(19) United States
(12) Patent Application Publication
(10) Pub. No.: US 2009/0098345 A1
(43) Pub. Date: Apr. 16, 2009

(54) Polymer-coated construction component and method

(76) Inventor: Jon H. Brasher, Auburn, AL (US)

Correspondence Address: LANIER FORD SHAVER & PAYNE P.C., P O BOX 2087, HUNTSVILLE, AL, 35804-2087, US

(21) Appl. No.: 11/872,532

(22) Filed: Oct. 15, 2007

(51) Int. Cl. B32B 3/00; B05D 5/00

(52) U.S. Cl. 428/173; 427/256

(57) ABSTRACT

A construction component is claimed having a substantially solid member with at least one opening and a layer of polymer applied to the solid member such that it coats at least a portion of a surface of the solid member and substantially fills the opening.

### FIELD OF THE INVENTION

The present disclosure relates generally to construction components. More particularly, the present disclosure relates to components capable of withstanding environments conducive to causing corrosion.

### BACKGROUND OF THE INVENTION

In coastal areas, construction straps, also called hurricane straps, are used with wooden structures to strengthen and stabilize the structure in high winds. Traditionally, these straps have been produced from steel. Many other construction components, including joist, beam or truss hangers, straps, gusset plates, supports, binders, and other metal items typically used to attach wood to wood, wood to concrete, or wood to steel, have traditionally been made out of steel as well. When a steel part is exposed to the atmosphere, it begins to rust. This is especially true in areas of high humidity, including coastal areas where hurricane straps are needed the most. Rusting will corrode and therefore weaken the part, making it unstable as well as aesthetically displeasing.

There are two common methods for protecting metals from corrosion. The first is barrier protection. Barrier protection involves isolating the metal from electrolytes in the environment by placing a barrier layer on the exposed surface of the metal. The second method of corrosion protection is cathodic protection. Cathodic protection involves introducing a new corrosion element as a sacrificial anode, ensuring that the protected metal becomes the cathode in the corrosion circuit. The sacrificial anode layer is more easily oxidized than the protected layer, and therefore corrodes first.

Galvanization is a process designed to protect underlying steel components from corrosion by providing both a protective barrier and cathodic protection. Galvanization involves coating steel parts with a protective layer of zinc. When zinc and ferrous metals are put together in the presence of oxygen, they lose electrons at the same time. However, since ferrous metals are less reactive and more electronegative than zinc, the protected metal will replace its own lost electrons with electrons from the zinc. The zinc on the surface of the steel component reacts with oxygen to form zinc oxide, which further reacts with water molecules in the air to form zinc hydroxide. The zinc hydroxide reacts with carbon dioxide to produce zinc carbonate. The zinc carbonate acts as the sacrificial anode as well as a barrier layer to prevent oxygen from coming into contact with the steel. Galvanization of construction components is typically performed by passing the steel component through a molten bath of zinc.

While galvanization slows down the corrosion process, the process is not eliminated due to the always existing presence of carbon dioxide in the air. Over time, the layer of zinc carbonate will corrode away, removing the sacrificial anode. The corrosion of the zinc layer allows the oxygen to come into physical contact with the steel, and the steel will begin to rust as a result, as the zinc is no longer present to act as a sacrificial anode by donating electrons to the steel. Additionally, humidity influences the rate of corrosion significantly. When the relative humidity is above fifty percent (50%), the rate of corrosion is exponential, and studies have shown that the average relative humidity exceeds 50% in the United States ninety percent (90%) of the time. Coastal areas, where certain construction components are needed the most due to the threat of hurricanes, tend to be more humid on average than the rest of the country, presenting a more urgent need for corrosion resistance.

### SUMMARY OF THE INVENTION

A construction component in accordance with an embodiment of the present disclosure comprises a substantially solid member having at least one opening; and a layer of polymer applied to the solid member such that it coats at least a portion of a surface of the solid member and substantially fills the opening.

A method in accordance with an embodiment of the present disclosure comprises the steps of providing a construction component having at least one opening, coating the construction component with a polymer thereby substantially filling the opening, and piercing the opening with a fastener.

### DESCRIPTION OF THE DRAWINGS

FIG. 1 is a top view of a prior art construction component.

FIG. 2 is a side view of a prior art construction component.

FIG. 3 is a top view of an exemplary construction component in accordance with an embodiment of the present disclosure.

FIG. 4 is a sectional view of an exemplary construction component taken along line A-A of FIG. 3 in accordance with an embodiment of the present disclosure.

FIG. 5 is a sectional view of an exemplary construction component with a connector fastening the construction component in accordance with an embodiment of the present disclosure, the section taken along line A-A of FIG. 3.

FIG. 6 illustrates an exemplary process according to the present invention.

Repeat use of reference characters throughout the present specification and appended drawings is intended to represent the same or analogous features or elements of the invention.

### DETAILED DESCRIPTION

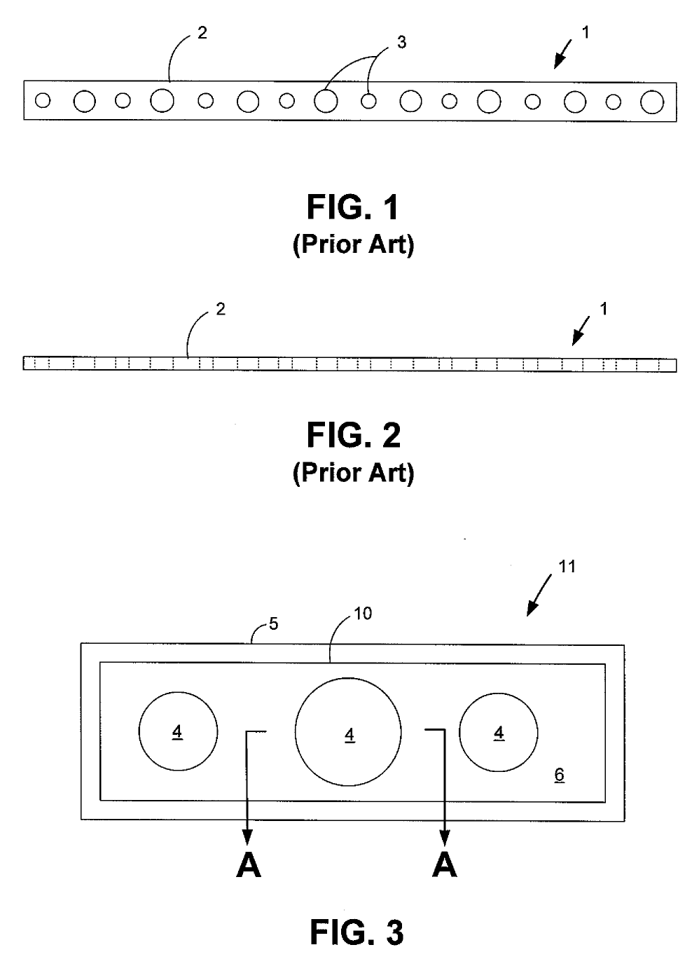

FIG. 1 and FIG. 2 illustrate a top view and side view, respectively, of a prior art construction component 1. The illustrated construction component 1 is a thin, solid strap 2 with holes 3 of varying sizes for receiving fasteners (not illustrated).

FIG. 3 illustrates a top view of a construction component 11 in accordance with an embodiment of the present disclosure. The construction component 11 comprises the base member 10, one or more openings 4, and a polymer coating 5. The coating 5 prevents any contact between the outside elements (not shown) and a surface 6 of the base member 10, thereby stifling any chemical reaction the base member 10 may have with its environment.

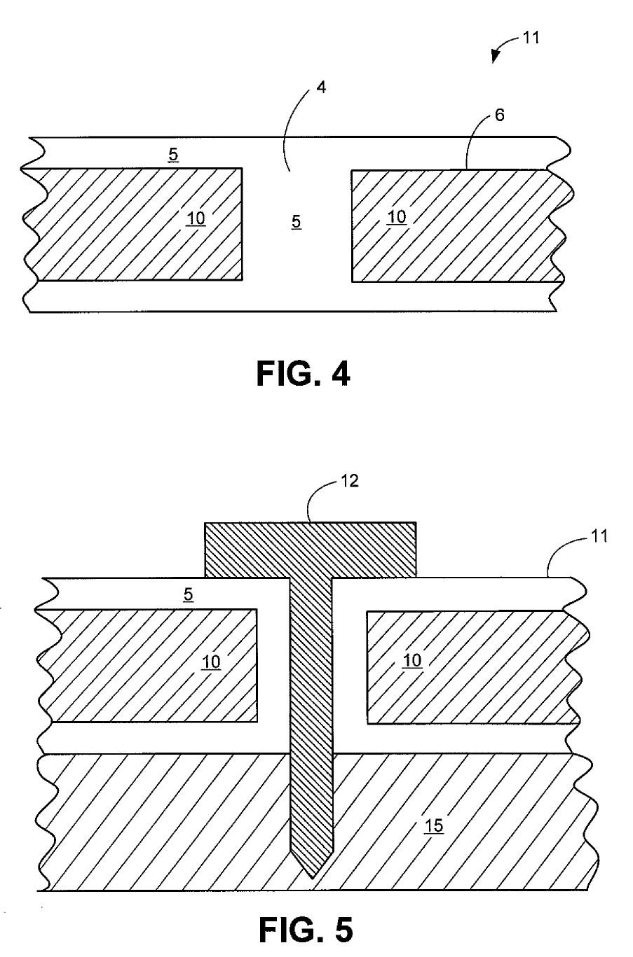

FIG. 4 is a cross-sectional view of the construction component 11 depicted in FIG. 3 in accordance with an embodiment of the present invention. The construction component 11 comprises a base member 10 having a plurality of openings 4 and a polymer coating 5, which coats the surface 6 of the base member 10. In addition, the polymer coating 5, when applied to the base member 10, substantially fills the opening 4. In this regard, the opening 4, when the polymer coating 5 is applied, is substantially filled with the polymer coating 5, thereby leaving it unexposed to the elements.

The polymer coating 5 may be of any thickness that is suitable for protecting the base member 10 from the elements and substantially filing the opening 4. In one embodiment of the invention, the polymer coating is 1/16 inches thick.

FIG. 5 is a cross sectional view of the construction component 11 depicted in FIG. 3, illustrating a fastener 12, e.g., a nail, screw or a bolt, driven through the opening 4 in the component 11 and into a solid material 15, e.g., a board. When the fastener 12 is driven through the polymer-filled opening 4, the polymer coating 5 surrounds the fastener 12. When the polymer coating 5 surrounds the fastener 12, the coating 5 is a barrier between the construction component 11 and the elements and thus prevents the base member 10 from being exposed to the elements.

Note that the afore-described disclosure may apply to any type of construction device known in the art or future-developed. As examples, the polymer coating 23 may be applied to a joist, beam or truss hanger, a gusset plate, a binder, a support, a pipe hangar, a pipe strap, a flashing, cave metal, rolled flashing, wall flashing, valley flashing, a chimney cap, a roof duct, a door frame or casing, a hasp, a hinge, a sliding bolt, or a door knob set.

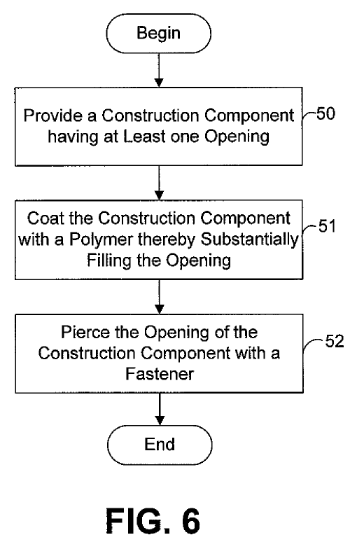

FIG. 6 depicts a method in accordance with an embodiment of the present disclosure. The method comprises the step of providing the construction component 11 (FIG. 3) having at least one opening 4, as indicated in step 50. As noted herein, the construction component 11 can be any number of construction components known in the art or future-developed having at least one opening 4.

The construction component 11 of step 50 is coated with a polymer coating 5 (FIG. 3) thereby substantially filling the opening 4, as indicated in step 51. Once the opening 4 is filled, a user (not shown) pierces the opening 4 with a fastener 12 (FIG. 5), as indicated in step 52.

What is claimed is:

1. A construction component, comprising:
a substantially solid member having at least one opening; and
a layer of polymer applied to the solid member such that it coats at least a portion of a surface of the solid member and substantially fills the opening.

2. The construction component of claim 1, further comprising a fastener inserted through the opening.

3. The construction component of claim 2, wherein the layer of polymer seals the opening around the fastener.

4. The polymer coated construction component of claim 1, wherein the substantially solid member is comprised of galvanized steel.

5. The construction competent of claim 1, wherein the layer of polymer is about 0.0625 thick.

6. A method, comprising the steps of:
providing a construction component having at least one opening;
coating the construction component with a polymer thereby substantially filling the opening; and
piercing the opening with a fastener.

7. The method of claim 6, wherein the polymer coating is about 0.0625 thick.
